(19) United States
(12) Patent Application Publication
(10) Pub. No.: US 2024/0171323 A1
(43) Pub. Date: May 23, 2024

(54) SYSTEMS AND METHODS FOR HYBRID AUTOMATIC REPEAT REQUEST ACKNOWLEDGEMENT PROCEDURE AND TRANSMISSION CONFIGURATION INDICATOR APPLICATION TIMELINE FOR BEAM INDICATION

(71) Applicant: ZTE CORPORATION, Shenzhen (CN)

(72) Inventors: Bo GAO, Shenzhen (CN); Zhaohua LU, Shenzhen (CN); Ke YAO, Shenzhen (CN); Shujuan ZHANG, Shenzhen (CN); Shijia SHAO, Shenzhen (CN)

(73) Assignee: ZTE CORPORATION, Shenzhen (CN)

(21) Appl. No.: 18/506,215

(22) Filed: Nov. 10, 2023

Related U.S. Application Data
(63) Continuation of application No. PCT/CN21/93005, filed on May 11, 2021.

(51) Int. Cl. H04L 1/1829; H04L 1/1867

(52) U.S. Cl. CPC H04L 1/1864; H04L 1/1896

(57) ABSTRACT

Presented are systems and methods for hybrid automatic repeat request acknowledgement (HARQ-ACK) procedure and transmission configuration indicator (TCI) application timeline for beam indication. A wireless communication device may receive a downlink control information (DCI) indicating a beam state to be applied to at least one signal from a wireless communication node. The wireless communication device may send HARQ-ACK information corresponding to the DCI to the wireless communication node using a physical uplink control (PUCCH) resource determined according to the DCI.

### CROSS-REFERENCE TO RELATED APPLICATION

This application claims the benefit of priority under 35 U.S.C. § 120 as a continuation of International Patent Application No. PCT/CN2021/093005, filed on May 11, 2021, the disclosure of which is incorporated herein by reference in its entirety.

### TECHNICAL FIELD

The disclosure relates generally to wireless communications, including but not limited to systems and methods for hybrid automatic repeat request acknowledgement (HARQ-ACK) procedure and transmission configuration indicator (TCI) application timeline for beam indication.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device may receive a downlink control information (DCI) indicating a beam state to be applied to at least one signal from a wireless communication node. The wireless communication device may send HARQ-ACK information corresponding to the DCI to the wireless communication node using a physical uplink control (PUCCH) resource determined according to the DCI.

In some embodiments, the at least one signal may comprise at least one of: a downlink (DL) signal or an uplink (UL) signal. In some embodiments, the wireless communication device may determine the PUCCH resource according to a PUCCH resource indicator (PRI) in the DCI. In some embodiments, the wireless communication device may generate a non-acknowledgment (NACK) value for the HARQ-ACK information if the wireless communication device fails to detect the DCI. In some embodiments, the wireless communication device may generate an acknowledgment (ACK) value for the HARQ-ACK information if the wireless communication device detects the DCI. In some embodiments, the HARQ-ACK information may include the NACK value or the ACK value. In some embodiments, the wireless communication node can preclude sending of the another HARQ-ACK information corresponding to the data channel reception if the HARQ-ACK information and another HARQ-ACK information corresponding to a data channel reception are associated with a same index (e.g., a same value of b_{r,k,n}_{_{D}} where b_{r,k,n}_{_{D}} denotes a index of occasion for candidate PDSCH reception, semi-persistent scheduling (SPS) PDSCH release or reference channel associated with row (r) (i.e., refers to a relative time-domain location/duration within a slot/time unit), offset from DL data to HARQ-ACK (k), downlink index (n_{D})), a same location of HARQ-ACK codebook, or a same occasion of candidate data channel reception. In some embodiments, the wireless communication node may send the HARQ-ACK information if the HARQ-ACK information and another HARQ-ACK information corresponding to a data channel reception are associated with a same index (e.g., a same value of b_{r,k,n}_{_{D}}, or a same index of occasion for candidate PDSCH reception, SPS PDSCH release or reference channel associated with row (r)), a same location of HARQ-ACK codebook, or a same occasion of candidate data channel reception.

In some embodiments, the wireless communication device may send the HARQ-ACK information X times if a mode of physical downlink shared channel (PDSCH) code block group transmission is enabled, and if the wireless communication device is configured with more than one serving cell, or if a number of candidate PDSCH receptions, semi-persistent scheduling (SPS) PDSCH releases or reference channels corresponding to the DCI is more than one. In some embodiments, the X can be an integer value configured by radio resource control (RRC) signaling or the DCI. In some embodiments, the wireless communication device may send the HARQ-ACK information without repetition if a mode of physical downlink shared channel (PDSCH) code block group transmission is enabled and at least one of: if the wireless communication device is configured with one serving cell or if the number of candidate PDSCH receptions, SPS PDSCH releases or reference channels corresponding to the DCI is one. In some embodiments, the beam state may be associated with a time domain offset parameter or another time domain offset parameter. In some embodiments, the at least one signal may comprise a periodic or semi-persistent reference signal (RS) or channel. In some embodiments, the wireless communication device may determine a time unit of the at least one signal according to the time domain offset parameter, wherein the beam state is associated with the time domain offset parameter. In some embodiments, the wireless communication device may determine a time unit of the at least one signal according to a preconfigured value and the another time domain offset parameter, wherein the beam state is associated with the another time domain offset parameter. In some embodiments, the wireless communication device may receive a radio resource control (RRC) signaling including a preconfigured value from the wireless communication node. In some embodiments, the wireless communication device may determine or maintain a periodicity of the at least one signal according to the preconfigured value.

In some embodiments, a periodicity parameter associated with the beam state may have a value that is same as a periodicity of a previous or last transmission of the at least one signal. In some embodiments, the wireless communication device may apply a value of the time domain offset parameter on the at least one signal, to replace a value preconfigured via a radio resource control (RRC) signaling. In some embodiments, the wireless communication device may determine a location of a reference channel corresponding to the DCI, according to a first parameter in an indicated time domain resource assignment (TDRA) field. In some embodiments, the wireless communication device may determine a location of the HARQ-ACK information in a HARQ-ACK codebook, according to the location of the reference channel. In some embodiments, the wireless communication device may determine the location of a reference channel by ignoring a k0 parameter in the TDRA field. In some embodiments, the first parameter may comprise a startSymbolAndLength (SLIV) parameter. In some embodiments, the location of the reference channel reception can be in a same time unit as the DCI. In some embodiments the wireless communication device may determine the location of a reference channel reception by using a k0 parameter and a startSymbolAndLength (SLIV) parameter as the first parameter. In some embodiments, the wireless communication device may send, to the wireless communication node, the HARQ-ACK information in a PUCCH transmission that is k1 number of time units after the DCI or after the reference channel. In some embodiments, the k1 can be indicated by the DCI, or by a radio resource control (RRC) signaling.

In some embodiments, the k1 may be indicated via a PDSCH-to-HARQ_feedback timing indicator field of the DCI. In some embodiments, the k1 may be indicated via a dl-DataToUL-ACK or dl-DataToUL-ACK-ForDCI-Format1-2-r16 parameter of the RRC signaling if the PDSCH-to-HARQ_feedback timing indicator field is absent. In some embodiments, a value corresponding to downlink data to HARQ-ACK, for determining a location of the HARQ-ACK information in a HARQ-ACK codebook, may be determined according to one of: a function of the k1, and a k0 parameter in the TDRA field, or (k1−k0) number of time units. In some embodiments, a set of slot timing values corresponding to the HARQ-ACK information may be determined according to differences in values of the k1 corresponding to the elements of HARQ-ACK information, relative to the k0. In some embodiments, the wireless communication device may receive or establish a table with rows associated with at least one of: the k0, values of a startSymbolAndLength (SLIV) parameter, or physical downlink shared channel (PDSCH) mapping types for the reference channel. In some embodiments, the reference channel may be at least a specific number of time units prior to the PUCCH resource. In some embodiments, k0 may be equal to 0, or the location of the reference channel can be in a same time unit as the DCI. In some embodiments, k0 can be greater than 0 if supported by a capability of the wireless communication device. In some embodiments, the HARQ-ACK information may be carried in a last or first bit in the HARQ-ACK codebook if k0<k1. In some embodiments, real and virtual instances of the reference channel reception can either overlap or not overlap.

In some embodiments, the wireless communication device may apply the beam state to the at least one signal according to K_{z} number of time units after receiving the DCI or after sending the HARQ-ACK information. In some embodiments, the K_{z} may be determined according to an indicated time domain resource assignment (TDRA) parameter. In some embodiments, the K_{z} may be determined according to at least one of: a value (K0) of a k0 parameter of an indicated time domain resource assignment (TDRA) parameter, or a time-domain offset value (Q) associated with the TDRA parameter. In some embodiments, the K_{z} may be determined as a value configured via radio resource control (RRC) signaling, if the DCI has a downlink assignment (DLA) indication. In some embodiments, the K_{z} may be determined a value selected by the DCI, from at least one candidate value configured via the RRC signaling or a medium access control control element (MAC-CE) signaling, if the DCI lacks a DLA indication.

At least one aspect is directed to a system, method, apparatus, or a computer-readable medium. A wireless communication node may send a downlink control information (DCI) indicating a beam state to be applied to at least one signal to a wireless communication device. The wireless communication node may receive HARQ-ACK information corresponding to the DCI from the wireless communication device using a physical uplink control (PUCCH) resource determined according to the DCI.

The systems and methods presented herein include a novel approach for supporting the retransmission of DCI by considering timeline issues of a HARQ procedure for DCI without DL assignment. Specifically, the systems and methods presented herein discuss a novel solution for allowing a semi-static HARQ procedure to handle the timeline of the DCI, the reference channel (e.g., the virtual PDSCH), and/or the PUCCH transmission by considering the HARQ-ACK codebook determination. The indicated TCI state application timeline, as well as certain combinations between a periodic reference signal (RS) parameter (e.g., time-domain offset) and/or the TCI state, are further enhanced to facilitate the usage of the DCI without DL assignment (e.g., without PDSCH scheduling).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates example approaches for beam based uplink (UL) and/or downlink (DL) transmissions, in accordance with some embodiments of the present disclosure;

FIGS. 4-6 illustrate example approaches for indicating/specifying a reference channel based on a DCI, in accordance with some embodiments of the present disclosure; and

FIG. 7 illustrates a flow diagram of an example method for HARQ-ACK procedure and TCI application timeline for beam indication, in accordance with an embodiment of the present disclosure.

### DETAILED DESCRIPTION

### 1. Mobile Communication Technology and Environment

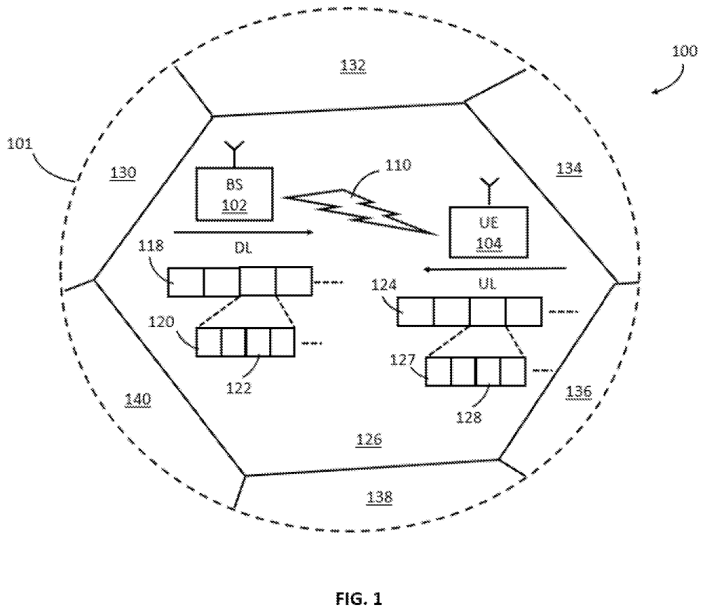

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

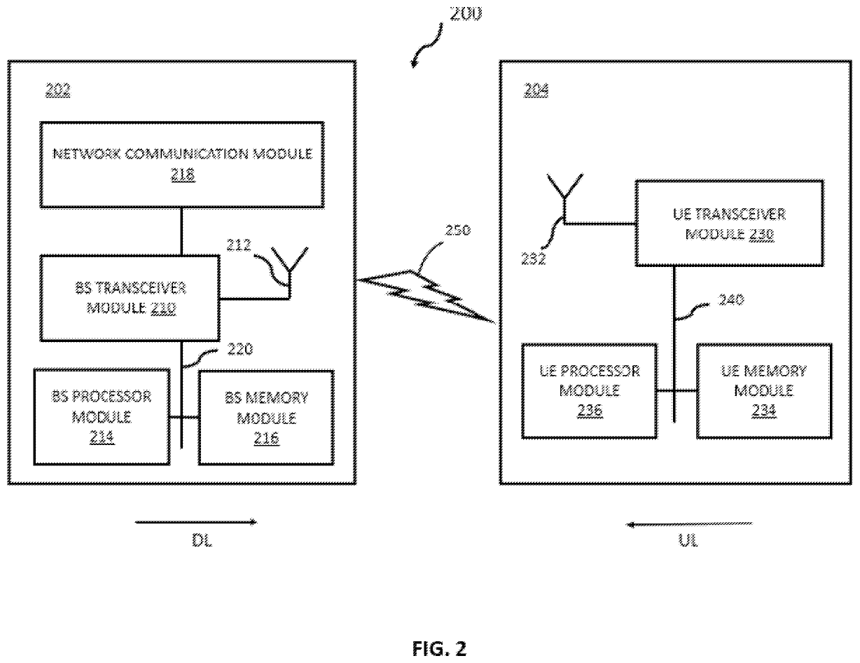

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for HARQ-ACK Procedure and TCI Application Timeline for Beam Indication

In certain systems (e.g., 5G new radio (NR), Next Generation (NG) systems, 3GPP systems, and/or other systems), downlink control information (DCI) specific to a wireless communication device (e.g., DCI format 1_1/1_2) may be used to schedule one or more physical downlink shared channel (PDSCH) and/or physical uplink shared channel (PUSCH) transmissions. As such, beam-specific DCI without PDSCH/PUCCH scheduling can be repurposed for beam indication, and/or decoupled from normal/routine PDSCH/PUSCH scheduling (also called downlink/uplink assignment). Beam-specific DCI without PDSCH/PUCCH scheduling can increase the flexibility of downlink (DL) and/or uplink (UL) beam indication, as well as reduce/decrease signalling overhead and/or reduce latency. Therefore, providing support for retransmissions can be essential to guarantee the robustness of beam-specific DCI.

In beam indication, analog beam-forming may be used/executed to increase/enhance the robustness of high frequency communications in certain systems (e.g., 5G NR, NG systems, and/or other systems). In some embodiments, a corresponding analog beam-forming indication (e.g., beam indication) may include one or more independent/separate indication procedures/processes for DL transmissions and/or uplink UL transmissions.

In some embodiments, a command (e.g., a DCI command) may be used to improve/enhance the performance of beam indication in user equipment (UE) high mobility scenarios. A command may be used to simultaneously update/upgrade/adjust/modify/change a beam of a DL data/control transmission (e.g., physical downlink control channel (PDCCH), PDSCH, channel state information reference signal (CSI-RS), and/or other signals/channels) and a beam of a UL data/control transmission (e.g., physical uplink control channel (PUCCH), PUSCH, sounding reference signal (SRS), and/or other channels/signals).

A hybrid automatic repeat request acknowledgement (HARQ-ACK) procedure for beam specific DCI may be used/implemented/designed in a common DL/UL beam indication framework to provide reliability/support for DCI retransmissions. The HARQ-ACK procedure for beam specific DCI (e.g., a DCI specific to a wireless communication device without scheduling PDSCH and/or for a group common DCI) may support the retransmission of the DCI specific to the wireless communication device (e.g., UE specific DCI) without PDSCH scheduling (also known as a beam-specific DCI command). The HARQ-ACK procedure for beam specific DCI may face/address one or more of the following issues/challenges:
1) The HARQ-ACK procedure may be divided/categorized/separated into at least two categories. The at least two categories may include a semi-static category, a dynamic category, and/or other categories for HARQ-ACK procedures. Regarding the semi-static category, a novel approach with a reception of a virtual PDSCH corresponding to a beam-specific DCI may be contemplated. The timeline of the beam-specific DCI (e.g., PDCCH reception, virtual PDSCH and/or ACK transmission occasion) can be considered. Accordingly, a corresponding bit location of the HARQ-ACK codebook may be determined.
2) Regarding the application timing of the indicated beam, a certain degree of flexibility for dynamical indication can be considered. Given that the DCI excludes redundant bits, one or more DCI fields may be repurposed to dynamically indicate the application timing of one or more updating beams.
3) A beam indicated via the DCI can be applied to DL and/or UL signals. However, for a periodic reference signal (RS), such as a DL and/or UL RS, the scheduling of the wireless communication node (e.g., a ground terminal, a base station, a gNB, an eNB, or a serving node) can be restricted/limited/regulated. For instance, the fixed beam pattern may be cell-specific rather than specific to a wireless communication device (e.g., a UE, a terminal, or a served node). Therefore, updating the beam used for a cell-specific RS may cause serious issues/problems for other wireless communication devices without beam updating requirements.

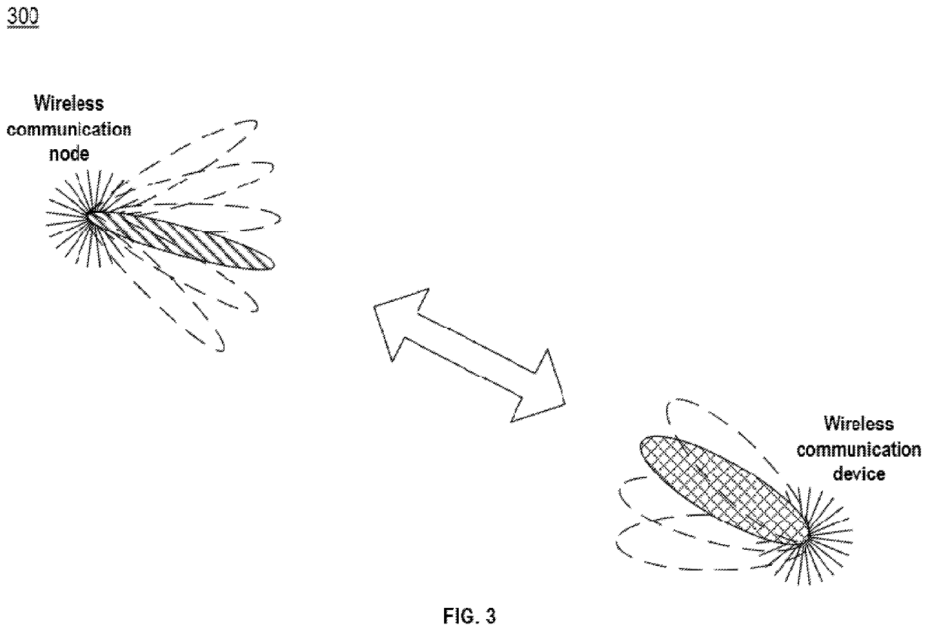

In certain systems, the use of high frequency resources may induce/produce/cause a considerable propagation loss. Therefore, wide and/or ultra-wide spectrum resources may pose/introduce/cause noticeable challenges (e.g., due to propagation loss). Referring now to FIG. 3, depicted is an example approach 300 for beam based UL and/or DL transmissions. Beam 302 and beam 304 of FIG. 3 may indicate/specify/represent a selected/identified transmit (Tx) beam and/or receive (Rx) beam for transmissions. In some embodiments, certain technologies/techniques may achieve/cause beam alignment and/or obtain/cause sufficient antenna gain. For example, antenna arrays and/or beam-forming training techniques that use massive multiple-input multiple-output (MIMO) (e.g., up to 1024 antenna elements for one node) may achieve beam alignment and/or sufficient antenna gain. In some embodiments, analog phase shifters may be used to implement/enable mmWave beam-forming. Using analog phase shifters may result in a low cost of implementation with the benefits of using antenna arrays. If analog phase shifters are used (e.g., to implement mmWave beam-forming), the number of controllable phases may be finite/defined/restricted. In some embodiments, the use of analog phase shifters may place/cause one or more constant modulus constraints on the analog phase shifters. Given a set of one or more pre-specified beam patterns, the goal/target of variable-phase-shift-based beamforming (BF) training may correspond to identifying/determining the optimum beam pattern for subsequent data transmissions. The identified beam pattern may apply to one or more scenarios with one transmit receive point (TRP) and/or one panel (e.g., a UE with one panel).

In some embodiments, a beam state may correspond/refer to a quasi co-location (QCL) state, a TCI state, a spatial relation state (or spatial relation information state), a reference signal (RS), a spatial filter, and/or pre-coding. In some embodiments, beam state may correspond to a beam. Specifically:
a) A Tx beam may correspond/refer to a QCL state, a TCI state, a spatial relation state, a DL/UL reference signal (e.g., a channel state information RS (CSI-RS), a synchronization signal block (SSB) or SS/PBCH, a demodulation reference signal (DMRS), a sounding reference signal (SRS), a physical random access channel (PRACH), and/or other signals), a Tx spatial filter, and/or Tx precoding.
b) A Rx beam may correspond/refer to a QCL state, a TCI state, a spatial relation state, a spatial filter, a Rx spatial filter, and/or Rx precoding.
c) A beam identifier (ID) may correspond/refer to a QCL state index, a TCI state index, a spatial relation state index, a reference signal index, a spatial filter index, a precoding index, and/or other indices.

In some embodiments, the spatial filter may correspond to the perspective of the wireless communication device and/or the wireless communication node. In some embodiments, the spatial filter may refer to a spatial-domain filter and/or other filters.

In some embodiments, a spatial relation information may comprise one or more reference RSs. The spatial relation information may be used to specify/indicate/convey/represent a same and/or quasi-co spatial relation between a targeted RS/channel and the one or more reference RSs. In some embodiments, a spatial relation may refer to a beam, a spatial parameter, and/or a spatial domain filter.

In some embodiments, a QCL state may comprise one or more reference RSs and/or one or more corresponding QCL type parameters. The QCL type parameters may include at least one of a Doppler spread, a Doppler shift, a delay spread, an average delay, an average gain, and/or a spatial parameter (e.g., a spatial Rx parameter). In some embodiments, a TCI state may correspond/refer to a QCL state. In some embodiments, a QCL Type D may correspond to a spatial parameter and/or a spatial Rx parameter. In some embodiments, an UL signal may include/comprise a PUCCH, a PUSCH, a SRS, and/or other channels/signals. In some embodiments, a DL signal may include/comprise a PDCCH, a PDSCH, a CSI-RS, and/or other channels/signals.

In some embodiments, a time unit may include a sub-symbol, a symbol, a slot, a sub frame, a frame, a transmission occasion, a millisecond and/or other time instances. In some embodiments, a power control parameter may include a target power (PO), a path loss RS (e.g., a coupling loss RS), a scaling factor for path loss (e.g., alpha), and/or a closed loop process. In some embodiments, a HARQ-ACK may correspond/refer to a hybrid automatic repeat request (HARQ), an acknowledgement/negative acknowledgement (ACK/NACK), an uplink acknowledgement (UL-ACK), and/or confirmation information for a transmission. In some embodiments, the DCI may correspond/refer to a PDCCH, a TCI indication command, a wireless communication device (e.g., UE) specific DCI, a group common DCI, DCI scheduling PUSCH/PDSCH, and/or DCI without scheduling PUSCH/PDSCH. In some embodiments, a DCI may correspond/refer to a PDCCH or a CORESET. In the description of the systems and methods presented herein, the term “DCI” may be used to refer to a beam specific DCI and/or a DCI indicating one or more TCI states if there is a lack of a specific/particular description.

In some embodiments, a reference channel may include/comprise a reference channel release, a reference channel validation, a reference channel reception and/or a reference channel transmission. In some embodiments, a reference channel reception may include or correspond to a reference PDSCH reception and/or a reference PDCCH reception. In some embodiments, a virtual PDSCH may include or correspond to a reference channel determination. In some embodiments, a reference channel transmission may include or correspond to a reference PUCCH transmission and/or a reference PUSCH transmission. In some embodiments, a reference channel may include or correspond to a PDSCH, a PDCCH, a PUCCH, a PUSCH, and/or other channels. In some embodiments, the reference channel may include or correspond to a virtual channel (e.g., virtual PDSCH for determining the location of HARQ-ACK information (corresponding to a PDCCH reception or DCI reception) in a HARQ-ACK codebook). In some embodiments, a release may correspond/refer to a deactivation. In some embodiments, a validation may correspond/refer to an activation and/or assignment.

### A. Embodiment 1: General Description of a HARQ-ACK Procedure for Beam Specific DCI

In some embodiments, an UL resource (e.g., a PUCCH resource and/or other resources) may carry/include/provide/specify/indicate the HARQ-ACK information. The HARQ-ACK information may be included/specified/located at a corresponding location in the HARQ-ACK codebook and/or used for ACK/NACK determination. A TCI indication may be used to specify/indicate/provide/identify at least one UL resource for a DCI command. In some embodiments, the DCI command may be used to update/modify/adjust at least one UL and/or DL beam. A report of HARQ-ACK information (or other information) may be used to determine/configure an applicable timing for updating/scheduling the at least one UL/DL beam. In some embodiments, a wireless communication device (e.g., a UE, a terminal, or a served node) may receive/obtain a DCI. The DCI may carry/include/provide/specify/indicate a beam state. The beam state can be applied to DL and/or UL signals.

In some embodiments, the DCI can be associated/related/linked with a PUCCH resource (and/or other resources). The PUCCH resource may carry/include/provide/specify the HARQ-ACK information.
In some embodiments, the DCI transmission may carry/include/specify/provide a PUCCH resource indicator (PRI) and/or other indicators. The PRI (or other indicators) may indicate/specify/identify the PUCCH resource(s).
   A parameter may be used to determine/configure a time offset between a PUCCH transmission and the DCI. The parameter may be configured/determined according to a capability of the wireless communication device, a predefined/predetermined configuration, radio resource control (RRC) signaling, medium access control control element (MAC-CE) signaling, the DCI or another DCI, and/or other configurations/signaling/information.

Of the embodiments discussed herein, Embodiment 2 may include/provide/specify one or more procedures/systems/operations to determine the location of the HARQ-ACK information (e.g., corresponding to the DCI) in the HARQ-ACK codebook in a semi-static procedure.
In some embodiments, the wireless communication device may fail to detect/identify the DCI. Responsive to failing to detect the DCI, the wireless communication device may generate/create a non-acknowledgement (NACK) value for reference channel and/or virtual PDSCH, for example.
   In some embodiments, the wireless communication device may receive/obtain one or more candidate PDSCHs. If the wireless communication device (successfully) receives one or more candidate PDSCHs (comprising the DCI beam state information), the wireless communication device may ignore/disregard/neglect the NACK value.
In some embodiments, the wireless communication device may detect/identify the DCI via one or more PDSCH receptions. Responsive to detecting the DCI, the wireless communication device may generate/create an acknowledgement (ACK) value for reference channel and/or virtual PDSCH.
In some embodiments discussed herein, a specific analysis of the dynamic procedure for HARQ-ACK reporting performed by the wireless communication device may not be considered.

In some embodiments, the DCI may be used to indicate/specify at least one TCI state (e.g., beam indication). The TCI state(s) can be applied to a DL and/or UL signal at a time location (e.g., time slot and/or other time instances) that is K_{z} time units after transmitting the HARQ-ACK information. In some embodiments, the TCI state(s) can be applied to a DL and/or UL signal at a time location corresponding to a time slot (or other time instances) after a time instance corresponding to the HARQ-ACK transmission plus (+) K_{z} time units. Of the embodiments discussed herein, Embodiment 3 may include/provide/specify additional details.

In some embodiments, at least one DL signal and/or UL signal may comprise a periodic and/or semi-persistent RS (e.g., CSI-RS for CSI and/or SRS). If the at least one DL/UL signal comprises a periodic and/or semi-persistent RS, the pattern of the periodic/semi-persistent RS (e.g., offset) and/or the QCL assumption can be dynamically updated through the indicating beam state.
In some embodiments, the beam state can be associated/related with a time domain offset parameter (e.g., periodicityAndOffset parameter and/or other parameters).
   In some embodiments, the periodicity of the at least one DL/UL signal may be maintained and/or determined according to (or based on) a preconfigured value, such as the time domain offset parameter. The preconfigured value may be determined/configured by using (or according to) higher-layer signaling, such as RRC signaling.
   In some embodiments, a periodicity of the periodic and/or semi-persistent RS (e.g., the current periodicity of the RS) may be same as (or correspond to) a periodicity of the beam state (e.g., the updated periodicity of the RS).
   For instance, for the periodic and/or semi-persistent RS, a value of a time domain offset (or other values) preconfigured via RRC signaling (and/or other types of signaling) may be replaced by a value of a time domain offset parameter on the at least one DL/UL signal (e.g., a time domain offset of the indicated beam state).

### B. Embodiment 2: Semi-static Procedure for Reporting a HARQ-ACK Information Bit

The location of the HARQ-ACK information in a HARQ-ACK codebook may be determined/calculated in semi-static procedures (e.g., a mode of the HARQ-ACK codebook is configured as “semi-static”). In some embodiments, the HARQ-ACK information may correspond to a DCI that indicates/specifies/identifies one or more TCI states.

Responsive to a successful reception of the DCI, the wireless communication device may report/provide/send/transmit an ACK. Responsive to a failed reception of the DCI, the wireless communication device may report/inform/transmit/communicate a NACK. The wireless communication device may determine/identify a location of the HARQ-ACK information in a HARQ-ACK codebook based on (or according to) a location of a reference channel, such as a virtual PDSCH (e.g., based on a time domain allocation list configured for the reference channel). The reference channel may correspond to (or be associated with) the DCI.

### I. Solution 1

In some embodiments, a location of the reference channel (e.g., the virtual PDSCH) can be indicated/specified by a first parameter (e.g., a startSymbolAndLength (SLIV) parameter and/or other parameters) in an indicated time domain resource assignment (TDRA) field of the DCI. The wireless communication device may determine/identify the location of the reference channel by ignoring a k0 parameter (e.g., a slot offset between the DCI and a corresponding scheduled PDSCH) in the TDRA field. In some embodiments, the reference channel (e.g., the virtual PDSCH) may be in a same/corresponding slot as a PDCCH reception (e.g., the DCI). In some embodiments, k0 and/or k₁ may indicate/specify a parameter and/or a value of a parameter.
In some embodiments, the wireless communication device may send/transmit/communicate/broadcast the HARQ-ACK information (e.g., an ACK) in a PUCCH transmission that is k₁ number of time units (e.g., a sub-symbol, a symbol, a slot, a sub frame, a frame, a transmission occasion, and/or other time instances) after the end of the PDCCH reception (e.g., the DCI transmission). The k₁ can be indicated/provided/specified by the DCI transmission (e.g., via a PDSCH-to-HARQ_feedback timing indicator field in the DCI) and/or by RRC signaling (e.g., via a dl-DataToUL-ACK and/or dl-DataToUL-ACK-ForDCI-Format1-2-r16 parameter of the RRC signaling if the PDSCH-to-HARQ_feedback timing indicator field is absent from the DCI).

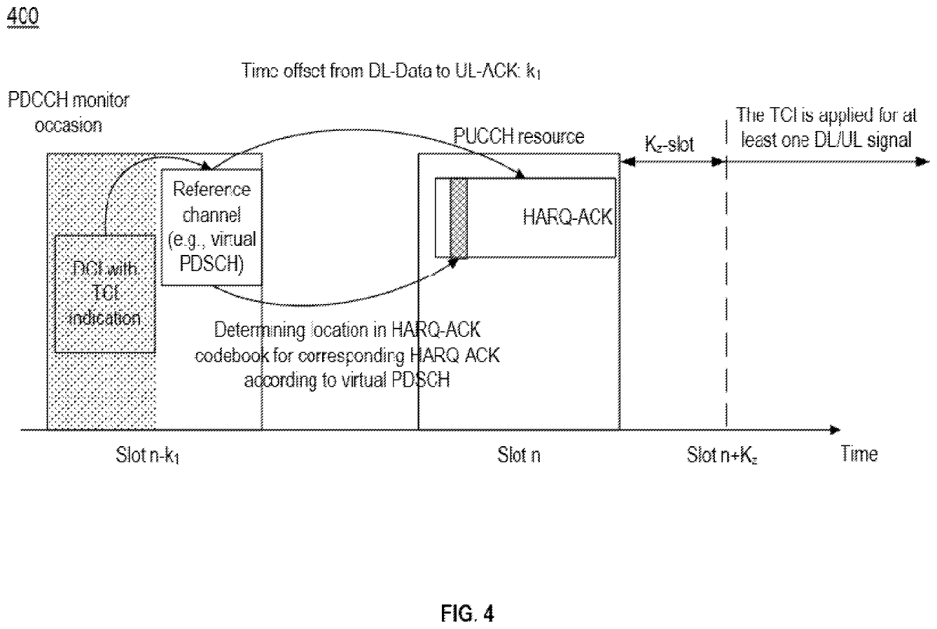

Referring now to FIG. 4, depicted is an example approach 400 for indicating a reference channel (e.g., a virtual PDSCH) in a same slot as a DCI transmission according to the DCI (e.g., according to a SLIV field of the TDRA field (k0 is ignored) in the DCI). In one example, the wireless communication device may receive/obtain the DCI in slot n−k₁ (or other time instances). The DCI may indicate a TCI for updating at least one beam of one or more UL/DL signals. The corresponding PDSCH reception (e.g., virtual PDSCH or other reference channel reception) can be determined according to a SLIV parameter (or other information) of the time domain resource parameter (or other parameters) for PDSCH (e.g., time domain resource allocation indication and/or TDRA field). The reference channel (e.g., the virtual PDSCH) can be in a same slot as the PDCCH reception (e.g., the DCI transmission).
The HARQ-ACK information bit corresponding to (or associated with) the DCI can be reported/specified/indicated in slot n (or other time units). The slot n may be k₁ number of time units (e.g., slots) after the DCI transmission. The k₁ time offset (e.g., from DL-Data to UL-ACK) may be configured/determined by (or according to) a parameter of RRC signaling (e.g., a k₁ time offset is 3 slots). The corresponding location of the HARQ-ACK information in the HARQ-ACK codebook may be determined/identified according to (or based on) the reference channel reception.
K_{z} number of time units (e.g., slots or millisecond) after transmitting/communicating the HARQ-ACK information, the indicated TCI (e.g., indicated by the DCI transmission) can be applied to at least one signal (e.g., a DL signal and/or an UL signal).

### II. Solution 2

In some embodiments, a location of the reference channel reception (e.g., the virtual PDSCH) may be indicated/provided/specified by a first parameter in the indicated TDRA field. For instance, the wireless communication device may determine/identify the location of the reference channel reception according to (or by using) a k0 parameter and/or a SLIV parameter (or other parameters) in the DCI. In some embodiments, the time unit (e.g., the slot) of the reference channel may be different/separate/distinct from (and/or the same as) the PDCCH reception (e.g., the DCI).
In some embodiments, the wireless communication device may send/transmit/communicate/provide/indicate/specify the HARQ-ACK information (e.g., the ACK) in a PUCCH transmission that is k₁ number of time units (e.g., slots) after the end of the reference channel reception. The DCI transmission may indicate/provide/specify the k₁ (e.g., via a PDSCH-to-HARQ_feedback timing indicator field of the DCI transmission). In some embodiments, RRC signaling (or other types of signaling, such as MAC-CE signaling) may provide the k₁ (e.g., via a dl-DataToUL-ACK or dl-DataToUL-ACK-ForDCI-Format1-2-r16 parameter of the RRC signaling if the PDSCH-to-HARQ_feedback timing indicator field is absent from the DCI).

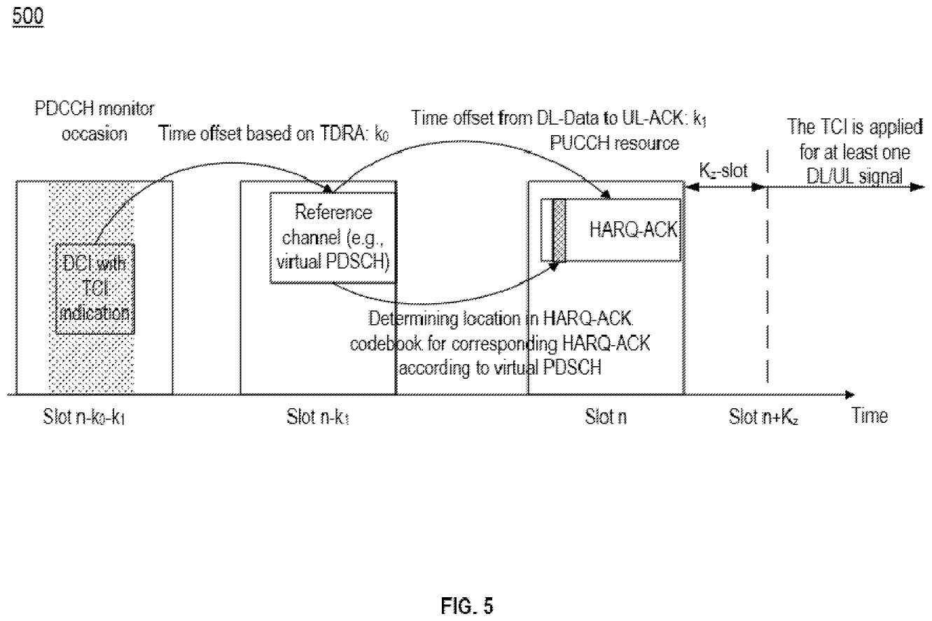

Referring now to FIG. 5, depicted is an example approach 500 for indicating a reference channel (e.g., a virtual PDSCH) according to a DCI transmission (e.g., according to a k0 and/or SLIV field of the TDRA field in the DCI). In one example, the wireless communication device may receive/obtain the DCI in slot n−k₀−k₁ (or other time instances). The DCI may indicate a TCI for updating at least one beam of one or more UL/DL signals. The corresponding PDSCH reception (e.g., virtual PDSCH or other reference channel reception) can be determined according to at least one time domain resource parameter (or other parameters) for PDSCH, such as the k0 and/or the SLIV information of the time domain resource parameter for the PDSCH (e.g., time domain resource allocation indication and/or TDRA field). The reference channel (e.g., the virtual PDSCH) can be in a slot (or other time units) n−k₁.
The HARQ-ACK information bit corresponding to (or associated with) the DCI can be reported/specified/indicated in slot n (or other time units). The slot n may be k₁ number of time units (e.g., slots) after the reference channel transmission (e.g., the virtual PDSCH). The k₁ time offset (e.g., from DL-Data to UL-ACK) may be configured/determined by (or according to) a parameter of RRC signaling (e.g., a k₁ time offset is 3 slots). The corresponding location of the HARQ-ACK information in the HARQ-ACK codebook may be determined/identified according to (or based on) the reference channel reception.
K_{z} number of time units (e.g., slots or milliseconds) after transmitting/communicating the HARQ-ACK information, the indicated TCI (e.g., indicated by the DCI transmission) can be applied to at least one signal (e.g., a DL signal and/or an UL signal).

### III. Solution 3

In some embodiments, a location of the reference channel reception (e.g., the virtual PDSCH) may be indicated/provided/specified by a first parameter in the indicated TDRA field. For instance, the wireless communication device may determine/identify the location of the reference channel reception according to (or by using) a k0 parameter and/or a SLIV parameter (or other parameters) in the DCI. In some embodiments, the time unit (e.g., the slot) of the reference channel may be different/separate/distinct from (and/or the same as) the PDCCH reception (e.g., the DCI).
In some embodiments, the wireless communication device may send/transmit/communicate/provide/indicate/specify the HARQ-ACK information (e.g., the ACK) in a PUCCH transmission that is k₁ number of time units (e.g., slots) after the end of the PDCCH reception (e.g., the DCI transmission). The DCI transmission may indicate/provide/specify the k₁ (e.g., via a PDSCH-to-HARQ_feedback timing indicator field of the DCI transmission). In some embodiments, RRC signaling (or other types of signaling, such as MAC-CE signaling) may provide/specify/indicate the k₁ (e.g., via a dl-DataToUL-ACK or dl-DataToUL-ACK-ForDCI-Format1-2-r16 parameter of the RRC signaling if the PDSCH-to-HARQ_feedback timing indicator field is absent from the DCI).

In some embodiments, a value corresponding to downlink data to HACK-ACK (e.g., dl-DataToUL-ACK) may be determined/identified according to (or based on) one of: a function of the k1 and a k0 parameter in the TDRA field, and/or a (k1−k0) number of time units. The value corresponding to downlink data to HACK-ACK can be used for determining a location of the HARQ-ACK information in a HARQ-ACK codebook.
In some embodiments, a set of slot timing values corresponding to the HARQ-ACK information may be determined according to (or based on) differences in values of the k1 corresponding to the elements of HARQ-ACK information, relative to the k0 (e.g., k1−k0)
In some embodiments, a wireless communication device may receive/obtain/establish a table with rows (e.g., a number of rows R) associated with (or related to) at least one of: the k0, start and length indicators, values of a SLIV parameter, and/or PDSCH mapping types for the reference channel (e.g., the virtual PDSCH reception).
   A subcarrier spacing (SCS) for different/separate/distinct DL and/or UL signals can be considered for scenarios with a plurality of DL slots (or other time units) within a DL slot.
In some embodiments, a reference channel reception (e.g., a virtual PDSCH) may be at least a specific number of time units (e.g., X time units) prior to the PUCCH resource.
In some embodiments, k0=0 (e.g., indicated in the TDRA), and/or the location of the reference channel reception (e.g., the virtual PDSCH) can be in a same slot as the DCI transmission (e.g., the PDCCH reception).
   In some embodiments, k0 can be greater than 0 (k0>0) if supported by a capability of the wireless communication device.
If k0<k1, the HARQ-ACK information can be carried/included/specified/indicated in a last or first bit in the HARQ-ACK codebook.
In some embodiments, real and virtual instances of the reference channel reception (e.g., real PDSCH and virtual PDSCH) can either overlap or not overlap.

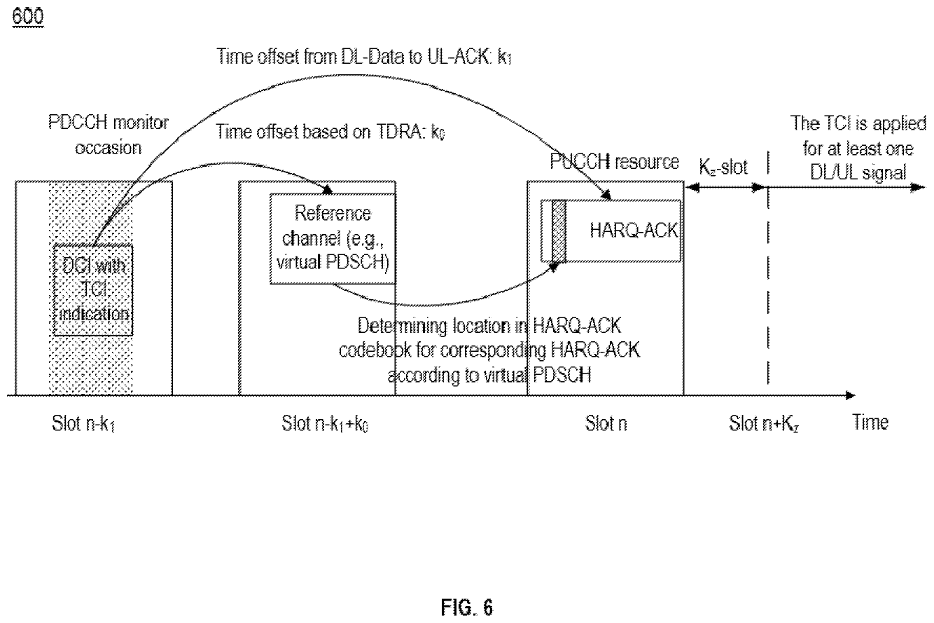

Referring now to FIG. 6, depicted is an example approach 600 for indicating a reference channel (e.g., a virtual PDSCH) according to a DCI transmission (e.g., according to a k0 and/or SLIV field of the TDRA field in the DCI). In one example, the wireless communication device may receive/obtain the DCI in slot n−k₁ (or other time instances). The DCI may indicate a TCI for updating at least one beam of one or more UL/DL signals. The corresponding PDSCH reception (e.g., virtual PDSCH or other reference channel reception) can be determined according to at least one time domain resource parameter (or other parameters) for PDSCH, such as the k0 and/or the SLIV information of the time domain resource parameter for the PDSCH (e.g., time domain resource allocation indication and/or TDRA field). The reference channel (e.g., the virtual PDSCH) can be in a slot (or other time units) n−k₁+k₀.
The HARQ-ACK information bit corresponding to (or associated with) the DCI can be reported/specified/indicated in slot n (or other time units). The slot n may be k₁ number of time units (e.g., slots) after the reference channel transmission (e.g., the virtual PDSCH). The k₁ time offset (e.g., from DL-Data to UL-ACK) may be configured/determined by (or according to) a parameter of RRC signaling (e.g., a k₁ time offset is 3 slots). The corresponding location of the HARQ-ACK information in the HARQ-ACK codebook may be determined/identified according to (or based on) the reference channel reception.
K_{z} number of time units (e.g., slots or millisecond) after transmitting/communicating the HARQ-ACK information, the indicated TCI (e.g., indicated by the DCI transmission) can be applied to at least one signal (e.g., a DL signal and/or an UL signal).

### C. Embodiment 3: Timeline for Beam State Application

If the DCI is used for TCI indication (e.g., beam indication), the TCI state can be applied to at least one signal (e.g., DL and/or UL signals) K_{z} time units after transmitting the HARQ-ACK. In some embodiments, the TCI state can be applied starting from a slot after a time point of transmitting the HARQ-ACK+K_{z} time units. If the DCI is used for TCI indication, the TCI state may be applied to at least one signal K_{z} time units after receiving the DCI. In some embodiments, the TCI state can be applied starting from a slot after a time point of receiving the DCI+K_{z} time units.
In some embodiments, K_{z} may be determined according to (or based on) a k0 value of the TDRA parameter. In some embodiments, K_{z} may be determined according to a time-domain offset (Q) associated with the TDRA parameter. In some embodiments, at least one candidate value of K_{z} can be configured via RRC signaling and/or MAC-CE signaling. The DCI may indicate/specify/select/determine a value of K_{z}.
   In some embodiments, K_{z} can be used to provide/specify/indicate an offset Q+k0.
   For instance, for solution 1 in embodiment #1, a starting point can be from the PUCCH and/or DCI transmission.
   Considering the compatibility for normal DCI format 1_1/2 with downlink assignment (DLA):
      The K_{z} can be determined as a value configured via RRC signaling (e.g., the first entry), if the DCI has a downlink assignment (DLA) indication.
      The K_{z} can be determined as a value selected by the DCI, from at least one candidate value configured via the RRC signaling and/or a MAC-CE signaling, if the DCI lacks a DLA indication.

### D. HARQ-ACK Procedure and TCI Application Timeline for Beam Indication

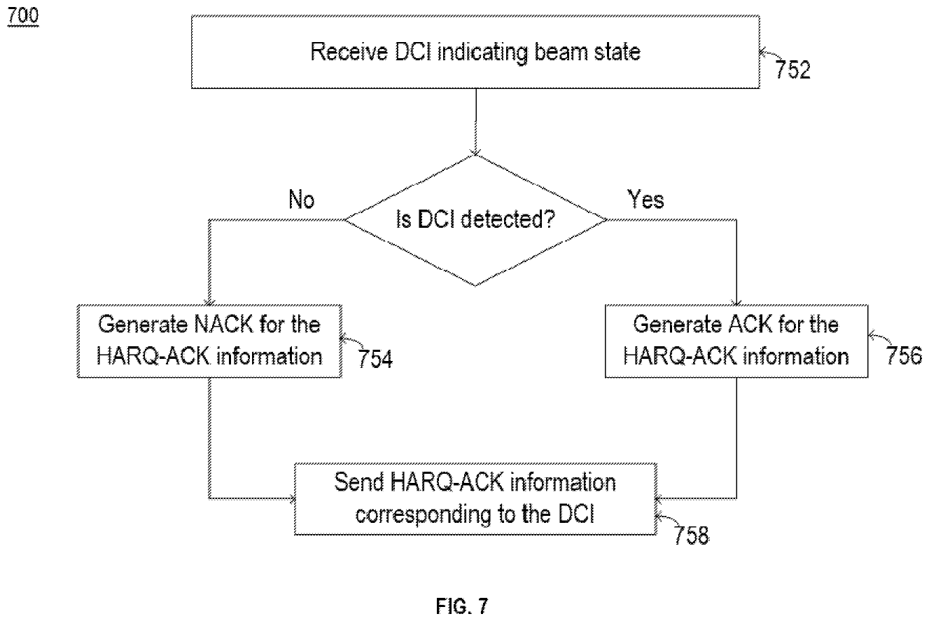

FIG. 7 illustrates a flow diagram of a method 700 for HARQ-ACK procedure and TCI application timeline for beam indication. The method 700 may be implemented using any of the components and devices detailed herein in conjunction with FIGS. 1-6. In overview, the method 700 may include receiving a DCI indicating a beam state (752). The method 700 may include generating a NACK for the HARQ-ACK information (754). The method 700 may include generating an ACK for the HARQ-ACK information (756). The method 700 may include sending HARQ-ACK information corresponding to the DCI (758).

Referring now to operation (752), and in some embodiments, a wireless communication device (e.g., a UE) may receive/obtain a DCI indicating a beam state. For instance, a wireless communication node (e.g., a gNB) may send/transmit a DCI indicating a beam state to the wireless communication device. The wireless communication device may receive/obtain the DCI indicating the beam state, wherein the beam state can be applied to at least one signal. The at least one signal may comprise at least one of: an UL signal and/or a DL signal, such as a PUCCH, a PUSCH, a SRS, a PDCCH, a PDSCH, a CSI-RS, and/or other UL/DL signals. In some embodiments, the beam state may be associated with (or related to) a time domain offset parameter (e.g., periodicityAndOffset and/or other parameters) and/or another time domain offset parameter. In some embodiments, the at least one signal may comprise/include a periodic or semi-persistent reference signal (RS) and/or channel.

In some embodiments, the wireless communication device may determine/configure a time unit (e.g., a sub-symbol, a symbol, a slot, a sub frame, a frame, a transmission occasion, and/or other time instances) of the at least one signal (e.g., a DL signal and/or a UL signal). The wireless communication device may determine the time unit according to (or based on) the time domain offset parameter (or other parameters). The beam state may be associated with (or related to) the time domain offset parameter (or other parameters). In some embodiments, the wireless communication device may determine a time unit of the at least one signal according to (or based on) a preconfigured value and/or the another time domain offset parameter (e.g., the time domain offset corresponding to the at least one signal is equal to the preconfigured value plus the another time domain offset parameter). The beam state can be associated with the another time domain offset parameter. In some embodiments, the wireless communication device may receive/obtain a RRC signaling (and/or other types of signaling, such as MAC-CE signaling). The RRC signaling may include/provide/specify/indicate a preconfigured value (e.g., in a periodicityAndOffset parameter of the RRC configuration) from the wireless communication node. In some embodiments, the wireless communication device may determine and/or maintain a periodicity of the at least one signal (e.g., a periodic/semi-persistent RS) according to (or based on) the preconfigured value (e.g., a pre-configured time-domain offset value). In some embodiments, a periodicity parameter associated with (or related to) the beam state (e.g., indicated via the DCI) may have a value that is same as (or correspond to) a periodicity of a previous or last transmission of the at least one signal (e.g., a periodicity of a RS). In some embodiments, the wireless communication device may apply/use a value of the time domain offset parameter on the at least one signal, to replace/reconfigure a value preconfigured via a RRC signaling (and/or other types of signaling). For instance, for a periodic/semi-persistent RS, the RRC preconfigured time-domain offset can be replaced by that of the indicated beam state (e.g., indicated via the DCI).

In some embodiments, the wireless communication device may determine/identify a location of a reference channel (e.g., a virtual PDSCH) corresponding to the DCI. The wireless communication device may determine the location of the reference channel according to (or by using) a first parameter (e.g., a startSymbolAndLength (SLIV) parameter and/or other parameters) in an indicated TDRA field. In some embodiments, the wireless communication device may determine/identify a location of the HARQ-ACK information (e.g., an ACK value) in a HARQ-ACK codebook according to (or based on) the location of the reference channel. In some embodiments, the wireless communication device may determine/identify the location of a reference channel by ignoring (e.g., not using) a k0 parameter (or other parameters) in the TDRA field. In some embodiments, the first parameter may comprise a startSymbolAndLength (SLIV) parameter and/or other parameters. In some embodiments, the location of the reference channel reception can be in a same time unit (e.g., a same slot) as the DCI. In some embodiments, the DCI may be equivalent to the PDCCH.

In some embodiments the wireless communication device may determine/identify the location of a reference channel reception (e.g., a virtual PDSCH reception) by using (or according to) a k0 parameter and/or a SLIV parameter as the first parameter. In some embodiments, the wireless communication device may send/transmit/communicate the HARQ-ACK information to the wireless communication node. The wireless communication device may send the HARQ-ACK information (e.g., an ACK and/or NACK values) in a PUCCH transmission (or other transmissions). The PUCCH transmission can be k1 number of time units (e.g., slots, symbols, and/or other time units) after the DCI and/or after the reference channel. In some embodiments, the k1 can be indicated/specified/provided/configured by the DCI, and/or by RRC signaling (or other types of signaling, such as MAC-CE signaling). In some embodiments, the k1 may be indicated via a PDSCH-to-HARQ_feedback timing indicator field of the DCI (or other fields of the DCI). In some embodiments, the k1 may be indicated via a dl-DataToUL-ACK or dl-DataToUL-ACK-ForDCI-Format1-2-r16 parameter of the RRC signaling (or other parameters of the RRC signaling) if the PDSCH-to-HARQ_feedback timing indicator field is absent. In some embodiments, a value corresponding to downlink data to HARQ-ACK may be determined/identified according to (or based on) one of: a function of the k1, a k0 parameter in the TDRA field, and/or (k1−k0) number of time units. The value corresponding to DL data to HARQ-ACK can be used for determining a location of the HARQ-ACK information in a HARQ-ACK codebook.

In some embodiments, a set of slot timing values corresponding to (or associated with) the HARQ-ACK information may be determined according to (or based on) differences in values of the k1 (corresponding to the elements of HARQ-ACK information) relative to the k0. In some embodiments, the wireless communication device may receive/obtain and/or establish/configure/generate a table with rows. The table with rows can be associated with at least one of: the k0, values of a SLIV parameter, and/or PDSCH mapping types for the reference channel. In some embodiments, the reference channel may be at least a specific number of time units prior to the PUCCH resource. In some embodiments, k0 may be equal to (or correspond to) 0 (or other values). In some embodiments, the location of the reference channel can be in a same/corresponding time unit as the DCI. In some embodiments, k0 can be greater than 0 if supported by a capability of the wireless communication device (e.g., UE capability). In some embodiments, the HARQ-ACK information may be carried/included/specified/indicated in a last and/or first bit in the HARQ-ACK codebook if k0<k1. In some embodiments, real and virtual instances of the reference channel reception can either overlap or not overlap. In some embodiments, the wireless communication device may apply the beam state to the at least one signal. The wireless communication device may apply the beam state according to (or based on) K_{z} number of time units (e.g., K_{z} slots or millisecond) after receiving/obtaining the DCI and/or after sending/transmitting the HARQ-ACK information. In some embodiments, the K_{z} may be determined according to (or based on) an indicated TDRA parameter. In some embodiments, the K_{z} may be determined according to (or based on) at least one of: a value (K0) of a k0 parameter of an indicated time domain resource assignment (TDRA) parameter, and/or a time-domain offset value (Q) associated with the TDRA parameter. In some embodiments, if the DCI has a downlink assignment (DLA) indication, the K_{z} may be determined as a value configured via RRC signaling (or other types of signaling). In some embodiments, if the DCI lacks a DLA indication, the K_{z} may be determined as a value selected by the DCI from at least one candidate value. The at least one candidate value can be configured via the RRC signaling and/or a MAC-CE signaling (or other types of signaling).

Referring now to operation (758), and in some embodiments, the wireless communication device may send/transmit/communicate/provide HARQ-ACK information corresponding to the DCI. For instance, the wireless communication device may send/transmit the HARQ-ACK information (e.g., an ACK and/or a NACK) by using (or according to) a PUCCH resource. The PUCCH resource may be determined/identified according to (or based on) the DCI. As such, the wireless communication node may receive/obtain the HARQ-ACK information from the wireless communication device using (or according to) the PUCCH resource. In some embodiments, the wireless communication device may determine/identify the PUCCH resource according to (or based on) a PUCCH resource indicator (PRI) in the DCI (and/or other indicators/fields in the DCI). In some embodiments, the wireless communication device may detect/identify the DCI (e.g., via any one of multiple PDCCH receptions). If the wireless communication device fails to detect the DCI, the wireless communication device may generate/configure a NACK value for the HARQ-ACK information (754). If, instead, the wireless communication device detects the DCI, the wireless communication device may generate/configure an ACK value for the HARQ-ACK information (756). As such, the HARQ-ACK information may include/provide/specify/indicate the NACK value and/or the ACK value (and/or other values/information). In some embodiments, the wireless communication node can preclude/prevent sending of another HARQ-ACK information. The another HARQ-ACK information may correspond to (or be associated with) a data channel reception. The wireless communication node can preclude/prevent sending of the another HARQ-ACK information if the HARQ-ACK information and the another HARQ-ACK information are associated with (or related to) a same/corresponding index, a same/corresponding location of a HARQ-ACK codebook, and/or a same/corresponding occasion of candidate data channel reception. In some embodiments, the wireless communication node may send/transmit/communicate the HARQ-ACK information if the HARQ-ACK information and the another HARQ-ACK information are associated with (or related to) a same index, a same location of HARQ-ACK codebook, and/or a same occasion of candidate data channel reception.

In some embodiments, the wireless communication device may send/transmit/communicate the HARQ-ACK information X times. The wireless communication device may send the HARQ-ACK information X times (e.g., via repetition) if a mode of PDSCH code block group transmission is enabled, if the wireless communication device is configured with more than one serving cell, and/or if a number of candidate PDSCH receptions, semi-persistent scheduling (SPS) PDSCH releases and/or reference channels (corresponding to the DCI) is more than one. In some embodiments, the X can be an integer value configured by RRC signaling (and/or or other types of higher layer signaling) and/or the DCI (or other information). In some embodiments, the X may be a parameter N\hat{ }{CBG/TB, max)_{HARQ-ACK}. The parameter N\hat{ }{CBG/TB, max)_{HARQ-ACK} can be indicated/specified/provided by a RRC parameter (e.g., maxCodeBlockGroupsPerTransportBlock (maximum number of code-block-groups (CBGs) per TB)). In some embodiments, the wireless communication device may send/transmit the HARQ-ACK information without repetition (e.g., only sending the HARQ-ACK information). The wireless communication device may send the HARQ-ACK information without repetition (e.g., only sending the HARQ-ACK information) if a mode of PDSCH code block group transmission is enabled and/or at least one of: if the wireless communication device is configured with one serving cell and/or if the number of candidate PDSCH receptions, SPS PDSCH releases and/or reference channels corresponding to the DCI is one.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a downlink control information (DCI) indicating a beam state to be applied to at least one signal; and
sending, by the wireless communication device to the wireless communication node, using a physical uplink control (PUCCH) resource determined according to the DCI, hybrid automatic repeat request acknowledgement (HARQ-ACK) information corresponding to the DCI.

2. The method of claim 1, wherein the at least one signal comprises at least one of: a downlink (DL) signal or an uplink (UL) signal.

3. The method of claim 1, comprising:
determining, by the wireless communication device, the PUCCH resource according to a PUCCH resource indicator (PRI) in the DCI.

4. The method of claim 1, comprising:
generating, by the wireless communication device, an acknowledgment (ACK) value for the HARQ-ACK information if the wireless communication device detects the DCI.

5. The method of claim 1, wherein the beam state is associated with a time domain offset parameter or another time domain offset parameter, and the at least one signal comprises a periodic or semi-persistent reference signal (RS) or channel.

6. The method of claim 5, comprising at least one of:
determining, by the wireless communication device, a time unit of the at least one signal according to the time domain offset parameter, wherein the beam state is associated with the time domain offset parameter; or
determining, by the wireless communication device, a time unit of the at least one signal according to a preconfigured value and the another time domain offset parameter, wherein the beam state is associated with the another time domain offset parameter.

7. The method of claim 5, comprising:
receiving, by the wireless communication device from the wireless communication node, a radio resource control (RRC) signaling including a preconfigured
value; and
determining or maintaining, by the wireless communication device, a periodicity of the at least one signal according to the preconfigured value.

8. The method of claim 5, wherein a periodicity parameter associated with the beam state has a value that is same as a periodicity of a previous or last transmission of the at least one signal.

9. The method of claim 5, comprising:
applying, by the wireless communication device, a value of the time domain offset parameter on the at least one signal, to replace a value preconfigured via a radio resource control (RRC) signaling.

10. The method of claim 1, comprising:
determining, by the wireless communication device, a reference channel corresponding to the DCI, according to a first parameter in an indicated time domain resource assignment (TDRA) field; and
determining, by the wireless communication device, a location of the HARQ-ACK information in a HARQ-ACK codebook, according to the reference channel.

11. The method of claim 10, wherein the first parameter comprises a startSymbolAndLength (SLIV) parameter, and the reference channel is in a same time unit as the DCI.

12. The method of claim 10, comprising:
determining, by the wireless communication device, the location of a reference channel reception by using a k0 parameter and a startSymbolAndLength (SLIV) parameter as the first parameter.

13. The method of claim 1, comprising:
sending, by the wireless communication device to the wireless communication node, the HARQ-ACK information in a PUCCH transmission that is k1 number of time units after a reference channel, wherein the k1 is indicated by the DCI.

14. The method of claim 13, wherein the k1 is indicated via a PDSCH-to-HARQ_feedback timing indicator field of the DCI, or via a dl-DataToUL-ACK or dl-DataToUL-ACK-ForDCI-Format1-2-r16 parameter of the RRC signaling if the PDSCH-to-HARQ_feedback timing indicator field is absent.

15. The method of claim 13, comprising:
receiving or establishing, by the wireless communication device, a table with rows associated with at least one of: the k0, values of a startSymbolAndLength (SLIV) parameter, or physical downlink shared channel (PDSCH) mapping types for the reference channel.

16. The method of claim 13, wherein k0=0, or the location of the reference channel is in a same time unit as the DCI.

17. A method comprising,
sending, by a wireless communication node to a wireless communication device, a downlink control information (DCI) indicating a beam state to be applied to at least one signal; and
receiving, by the wireless communication node from the wireless communication device, using a physical uplink control (PUCCH) resource determined according to the DCI, hybrid automatic repeat request acknowledgement (HARQ-ACK) information corresponding to the DCI.

18. A wireless communication device, comprising:
at least one processor configured to:
receive, via a transceiver from a wireless communication node, a downlink control information (DCI) indicating a beam state to be applied to at least one signal; and
send, via the transceiver to the wireless communication node, using a physical uplink control (PUCCH) resource determined according to the DCI, hybrid automatic repeat request acknowledgement (HARQ-ACK) information corresponding to the DCI.

19. A wireless communication node, comprising,
at least one processor configured to:
send, via a transceiver to a wireless communication device, a downlink control information (DCI) indicating a beam state to be applied to at least one signal; and
receive, via the transceiver from the wireless communication device, using a physical uplink control (PUCCH) resource determined according to the DCI, hybrid automatic repeat request acknowledgement (HARQ-ACK) information corresponding to the DCI.

20. The wireless communication node of claim 19, wherein the at least one signal comprises at least one of: a downlink (DL) signal or an uplink (UL) signal.
